(19) United States
(12) Patent Application Publication
(10) Pub. No.: US 2006/0199720 A1
(43) Pub. Date: Sep. 7, 2006

(54) Plasmapheresis centrifuge bowl

(76) Inventor: Tien-Chu Juan, Taipei City (TW)

Correspondence Address: BIRCH STEWART KOLASCH & BIRCH, PO BOX 747, FALLS CHURCH, VA, 22040-0747, US

(21) Appl. No.: 11/334,393

(22) Filed: Jan. 19, 2006

(30) Foreign Application Priority Data
Jan. 21, 2005 (TW) 94201198

(51) Int. Cl. B04B 7/08

(52) U.S. Cl. 494/41; 494/64

(57) ABSTRACT

A plasmapheresis centrifuge bowl comprises a ring-shaped dynamic sealing assembly having a ring-shaped static frictional assembly and a ring-shaped rotary frictional upper cover, both of which have a sealing surface. A dynamic seal can be provided between the contacting portions of the sealing surfaces of the ring-shaped static frictional assembly and the ring-shaped rotary frictional upper cover. The ring-shaped static frictional assembly comprises a ring-shaped ceramic piece. A ring-shaped frictional area is provided on the ring-shaped rotary frictional upper cover, and the heat transfer rate of the ring-shaped frictional area is less than the heat transfer rate of the ring-shaped ceramic piece. When the plasmapheresis centrifuge bowl of the present invention is operated to treat the blood, the heat generated by the friction can be conducted and dissipated into the air via the ring-shaped ceramic piece. As a result, the rise in the temperature of the plasmapheresis due to the frictional heat can be effectively avoided.

### BACKGROUND OF THE INVENTION

1. Field of the Invention

The present invention relates to a plasmapheresis centrifuge bowl, and in particular to a plasmapheresis centrifuge bowl for treating the blood.

2. The Prior Arts

An efficient sealing assembly is necessary to be provided between the rotary assembly and the static assembly of a centrifuge, so that the matters containing in the centrifuge can be prevented from leaking outside or the foreign matters can be prevented from entering the centrifuge bowl to contaminate the matters therein. For example, in the centrifuge for treating the blood, the centrifuge bowl and the associated assemblies can rotate, but the conduits consisted of a liquid outlet and a liquid inlet are kept static. When treating the blood, an efficient rotary sealing assembly is necessary to be provided between the rotating elements and static elements, so that the aseptic state of the blood can be ensured. Further, when treating the polluted blood, the possible environmental pollution should be avoided.

The sealing assembly of the rotary centrifuge must be very efficient, and able to make the amount of the air leaking out of the system or permeating into the system to a minimum. Further, it must have a minimum frictional heat, provide a good effect of dissipating heat, bear the slight vibration and misalignment between the rotary assembly and the static assembly, and minimize the amount of the fine contaminating particles entering the blood to be treated. Further, most important of all, the rotary sealing assembly must have a lower manufacturing cost, so that it can be economical to discard after finishing single complete treatment of blood.

Recently, a variety of the rotary sealing assemblies for the centrifuge bowl have been developed and each has a good quality. For example, U.S. Pat. Nos. 4,300,717, 4,983,158 and 5,045,048 each discloses a rotary sealing assembly for the centrifuge. The rotary sealing assemblies disclosed in the above patent documents are each formed by contacting a static rigid low-friction element with a dynamic rigid element. As a result, a dynamic seal can be produced. Further, the conventional rotary sealing assembly additionally comprises a resilient element for providing a resilient static seal and a proper sealing force between the dynamic sealing surfaces.

FIG. 1 is an exploded perspective view of the conventional rotary sealing assembly for a blood centrifuge bowl. The conventional blood centrifuge bowl comprises a centrifuge bowl body 10, a dynamic sealing assembly 12 provided and adhered on the bowl mouth of the centrifuge bowl body 10, an upper integrated draining pipe element 14 penetrated through a central hole of the dynamic sealing assembly 12 and provided below the dynamic sealing assembly 12, a lower integrated draining pipe element 16 provided below the upper integrated draining pipe element 14, and a head assembly 18 mounted on the dynamic sealing assembly 12. Further, the dynamic sealing assembly 12 comprises an upper cover 122, a ring-shaped ceramic piece 124 mounted on the upper cover 122, a ring-shaped frictional piece 126 contacting with the ring-shaped ceramic piece 124, and a resilient element 128 provided on the ring-shaped frictional piece 126. In the centrifugal operation, the upper cover 122 can rotate together with the centrifuge bowl body 10, while the ring-shaped frictional piece 126 and the resilient element 128 are kept static. As a result, a rotary seal can be formed between the ring-shaped frictional piece 126 and the ring-shaped ceramic piece 124.

The above conventional rotary sealing assembly for the centrifuge bowl has a good quality, however, since the heat-conducting capacity of the ring-shaped ceramic piece 124 is better than that of the ring-shaped frictional piece 126, so that the heat generated by the friction between the ring-shaped frictional piece 126 and the ring-shaped ceramic piece 124 will be conducted into the blood within the centrifuge bowl body 10 via the ring-shaped ceramic piece 124 rather than dissipated in the air via the ring-shaped frictional piece 126. The heat conducted into the centrifuge bowl body 10 causes a rise in the temperature of the blood to be treated and in turn affects the quality of the plasmapheresis after being treated. Further, the conventional centrifuge bowl is formed by manufacturing individual parts and adhering them one by one, which causes a very complicated procedure in manufacturing and the related cost. Further, the conventional upper cover 122 is adhered to the bowl mouth of the centrifuge bowl body 10 by an adhesive. It is inconvenient to manufacture the upper cover by the above process. Further, after being adhered, the upper cover cannot be opened any more, which also causes a certain degree of inconvenience.

### SUMMARY OF THE INVENTION

In order to solve the drawbacks and inconvenience in the prior art, the object of the present invention is to provide a rotary sealing assembly for a plasmapheresis centrifuge bowl, whereby to reduce the heat generated by the rotating friction of the centrifuge bowl conducting into the blood within the centrifuge bowl.

Another object of the present invention is to provide a module of the rotary sealing assembly, whereby to reduce the time for assembling the plasmapheresis centrifuge bowl and in turn the manufacturing cost.

Another object of the present invention is to provide a plasmapheresis centrifuge bowl capable of opening and closing repeatedly, whereby to easily open the centrifuge bowl and be sealed when closing.

The plasmapheresis centrifuge bowl according to the present invention contains: a plasapheresis centrifuge bowl body; a ring-shaped dynamic sealing assembly movably locked on the bowl mouth of the plasapheresis centrifuge bowl body and having a ring-shaped static frictional assembly and a ring-shaped rotary frictional upper cover, the ring-shaped static frictional assembly and the ring-shaped rotary frictional upper cover each having a sealing surface, a dynamic seal provided between the contacting portions of the sealing surface of the ring-shaped static frictional assembly and the sealing surface of the ring-shaped rotary frictional upper cover; an integrated draining pipe assembly penetrating through the ring-shaped dynamic sealing assembly and provided below the ring-shaped dynamic sealing assembly; and a head assembly mounted on the ring-shaped dynamic sealing assembly and snapped to the integrated draining pipe assembly; where the ring-shaped static frictional assembly comprises a ring-shaped ceramic piece and a resilient element integrated on the ring-shaped ceramic piece, a ring-shaped frictional area is provided on the ring-shaped rotary frictional upper cover, and the heat transfer rate of the ring-shaped frictional area is lower than the heat transfer rate of the ring-shaped ceramic piece.

According to the present invention, when the plasmapheresis centrifuge bowl is operated to treat the blood, a contacting seal can be formed between the contacting areas of the static ring-shaped ceramic piece and the ring-shaped frictional area on the rotating ring-shaped rotary frictional upper cover. Since the heat transfer rate of the ring-shaped ceramic since is higher than the heat transfer rate the ring-shaped frictional area, the heat generated by the centrifugal friction of the ring-shaped ceramic piece and the ring-shaped frictional area will be conducted and dissipated into the air via the ring-shaped ceramic piece. As a result, the heat generated by the friction cannot be conducted into the plasmapheresis centrifuge bowl body via the ring-shaped rotary frictional upper cover. Therefore, the heat generated by the friction can be effectively prevented from conducting into the plasmapheresis centrifuge bowl body and thus the temperature of the blood to be treated can be prevented from rising to change the contents of the plasmapheresis.

Further, since the components used in the plasmapheresis centrifuge bowl of the present invention have been integrated together in advance when manufacturing, the number of the components needed to be assembled is fewer than that of the conventional plasmapheresis centrifuge bowl. Therefore, the time for assembling and the manufacturing cost can be reduced.

Further, in the plasmapheresis centrifuge bowl according to the present invention, the outer edge of the bowl mouth of the plasmapheresis centrifuge bowl is further provided with a plurality of locking grooves. The inside of the ring-shaped rotary frictional upper cover is also provided with a plurality of projections corresponding to the locking grooves. Each of the locking grooves downwardly forms an angle with respect to the horizontal line of the bowl mouth. As a result, when the ring-shaped rotary frictional upper cover rotates to cause the projections to enter the locking grooves, the rotary ring-shaped frictional upper cover can be tightly locked on the bowl mouth of the plasmapheresis centrifuge bowl body.

The present invention will be further explained with reference to the following embodiments. It should be understood that the embodiments are not used to limit the present invention. Various modifications and equivalent replacements can still occur to those skilled in this art without departing from the scope of the present invention.

### BRIEF DESCRIPTION OF THE DRAWINGS

FIG. 1 is an exploded perspective view of the conventional plasmapheresis centrifuge bowl;

FIG. 2 is an exploded perspective view of the plasmapheresis centrifuge bowl according to the present invention;

FIG. 2A is a side view of the bowl mouth of the plasmapheresis centrifuge bowl body shown in FIG. 2, as seen from the direction of A;

FIG. 2B is a bottom view of the ring-shaped rotary frictional upper cover shown in FIG. 2, as seen from the direction of B;

FIG. 3A is a cross-sectional view showing the original state in which the ring-shaped rotary frictional upper cover of the present invention is locked on the plasmapheresis centrifuge bowl body;

FIG. 3B is a cross-sectional view showing the finished state in which the ring-shaped rotary frictional upper cover of the present invention has been locked on the plasmapheresis centrifuge bowl body; and

FIG. 4 is a cross-sectional view showing the state in which the plasmapheresis centrifuge bowl of the present invention has been completely assembled.

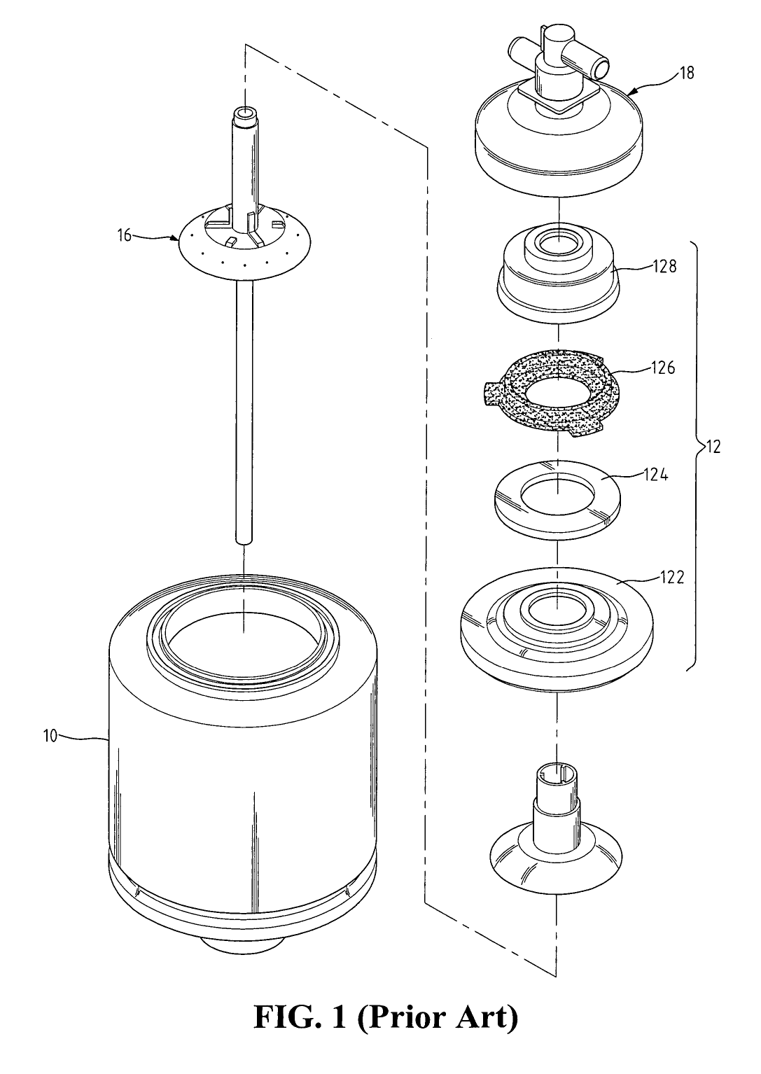

### DETAILED DESCRIPTION OF THE PREFERRED EMBODIMENT

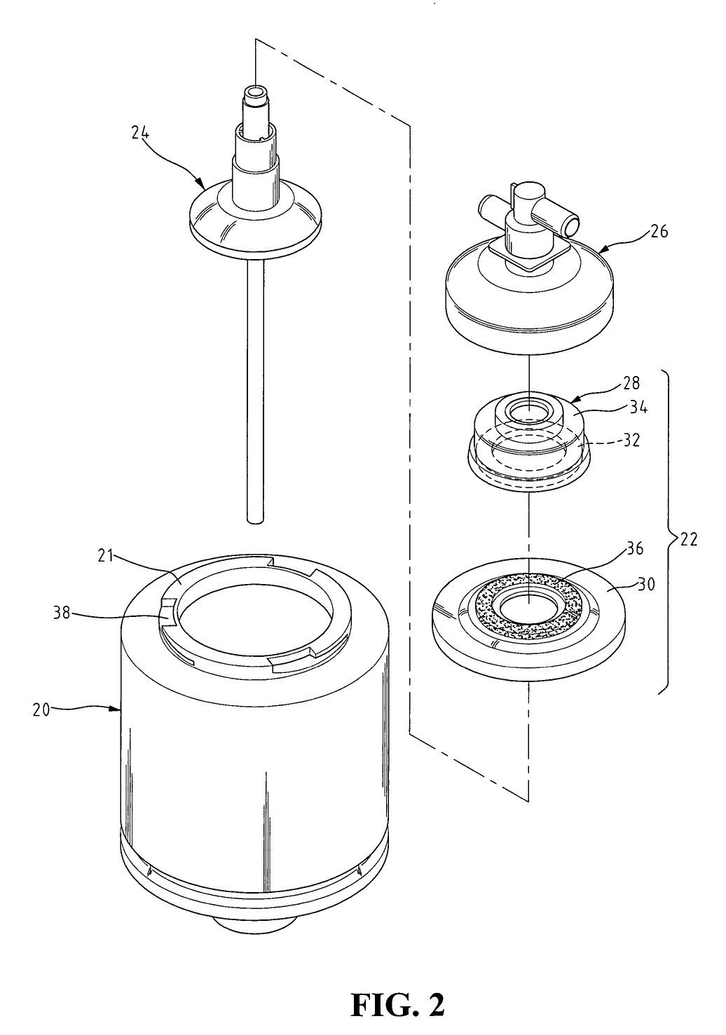

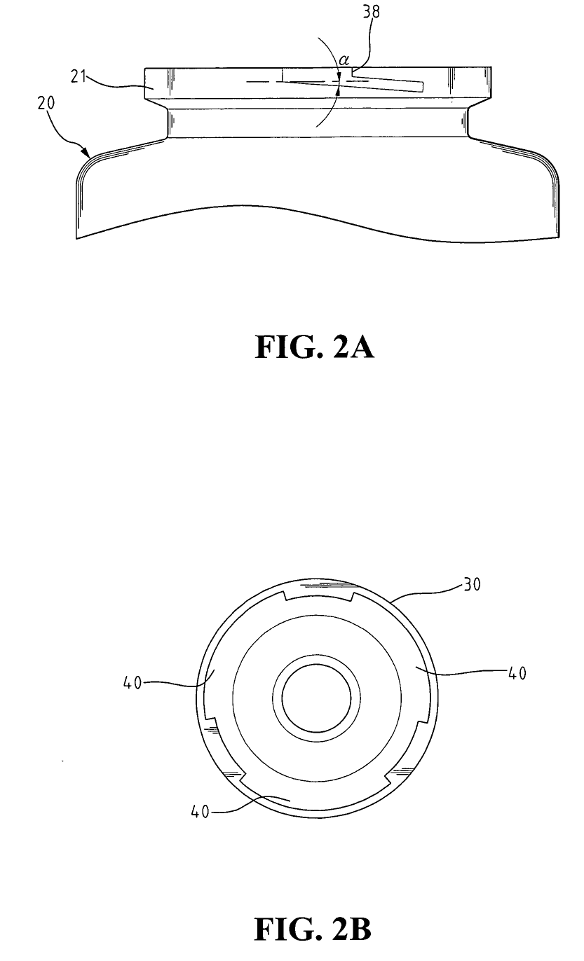

FIG. 2 is an exploded perspective view of the plasmapheresis centrifuge bowl of the present invention. The plasmapheresis centrifuge bowl 2 of the present invention comprises a plasmapheresis centrifuge bowl body 20, a ring-shaped dynamic sealing assembly 22 movably locked on the bowl mouth 21 of the plasmapheresis centrifuge bowl body 20, an integrated draining pipe assembly 24 provided below the ring-shaped dynamic sealing assembly 22 and partially penetrating through the ring-shaped dynamic sealing assembly 22, and a head assembly 26 mounted on the ring-shaped dynamic sealing assembly 22 and snapped on the integrated draining pipe assembly 24.

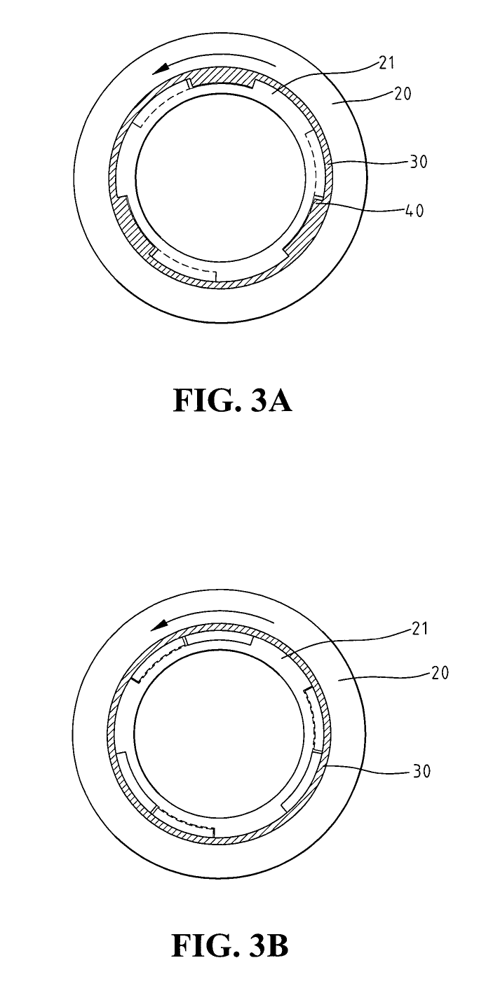

In the plasmapheresis centrifuge bowl body 20 of the present invention, the outside of the bowl mouth 21 is provided with a plurality of L-shaped grooves 38. The horizontal portion of the L-shaped groove inclines downwardly and forms an angle α with respect to the horizontal line of the mouth 21 (see FIG. 2A). Preferable range of the angle α is from 1 to 15 degrees, more preferably 3 to 10 degrees. The inside of the lower edge of the ring-shaped rotary frictional upper cover 30 is provided with projections 40 for locking the L-shaped grooves 38 at the positions corresponding to those of the L-shaped grooves 38 (see FIG. 2B). When the ring-shaped frictional upper cover 30 is locked on the bowl mouth 21 of the plasmapheresis centrifuge bowl body 20, the projections 40 provided on the inside of the lower edge of the ring-shaped rotary frictional upper cover 30 are firstly clasped with the L-shaped grooves 38 provided on the outside of the mouth 21 and corresponding thereto (see FIGS. 3A and 3B). Next, the ring-shaped rotary frictional upper cover 30 is further horizontally rotated to move downwardly each projection 40 with the horizontal portion of each L-shaped groove 38, so that the ring-shaped rotary frictional upper cover 30 is further attached on the bowl mouth 21 of the plasmapheresis centrifuge bowl body 20 to achieve the sealing. The number of the L-shaped grooves 38 provided on the outside of the bowl mouth 21 is preferably 2 to 6, more preferably 3 to 4. The number of the projections 40 provided on the inside of the lower edge of the ring-shaped rotary frictional upper cover 30 is preferably consistent with that of the L-shaped grooves 38.

When the conventional plasmapheresis centrifuge bowl body is assembled with the upper cover, an adhesive is coated on the attaching portion and then is cured by heating or supersonic. However, such procedure not only increases the time for assembling but also the adhesion maybe insufficient by mistake. On the contrary, when the plasmapheresis centrifuge bowl body 20 of the present invention is assembled with the ring-shaped rotary frictional upper cover 30, the adhesion is not necessary. By simply rotating the ring-shaped rotary frictional upper cover 30, the upper cover can be easily locked on the bowl mouth 21 of the plasmapheresis centrifuge bowl body 20 to achieve the sealing. As a result, the time for assembling this portion can be effectively reduced.

The integrated draining pipe assembly 24 of the present invention is made by integrating the conventional upper integrated draining pipe element with the lower integrated draining pipe element into one assembly in advance, so that the time for assembling the plasmapheresis centrifuge bowl can be reduced. The integrated draining pipe assembly 24 of the present invention can be manufactured by any conventional plastic forming techniques, such as injection molding. After integration, a clearance is still formed between the upper integrated draining pipe element and the lower integrated draining pipe element, so that the clearance is used to be a passage for draining off the blood after being treated.

Further, the ring-shaped dynamic sealing assembly 22 of the present invention is comprised of a ring-shaped static frictional assembly 28 and a ring-shaped rotary frictional upper cover 30. The ring-shaped static frictional assembly 28 and the ring-shaped rotary frictional upper cover 30 each have a sealing surface, respectively. Between the contacting portions of the sealing surfaces, a dynamic seal is provided. In order to achieve the dynamic seal, the ring-shaped static frictional assembly 28 further comprises a ring-shaped ceramic piece 32 and a resilient element 34 integrated on the ring-shaped ceramic piece 32. The resilient element 34 provides a resilient pressure to force the ring-shaped ceramic piece 32 to attach on the ring-shaped rotary frictional upper cover 30 to provide a resilient static seal. In addition to provide a resilient static seal, a proper sealing force can be provided between the surfaces of the dynamic seal. Further, the resilient element 34 can also cause the ring-shaped dynamic sealing assembly 22 to bear the slight vibration and misalignment between the rotary assembly and the static assembly. Further, a ring-shaped frictional area 36 is provided on the ring-shaped rotary frictional upper cover 30, and the heat transfer rate of the ring-shaped frictional area 36 is less than the heat transfer rate of the ring-shaped ceramic piece 32. As a result, when the plasmapheresis centrifuge bowl of the present invention is treating the blood, the heat generated by the ring-shaped frictional area 36 on the ring-shaped rotary frictional upper cover 30 and the ring-shaped ceramic piece 32 can be conducted in the direction away from the plasmapheresis centrifuge bowl body 20 via the ring-shaped ceramic piece 32 having higher heat transfer rate and then dissipated into the air. Therefore, the heat generated by the friction can be effectively prevented form conducting into the plasmapheresis centrifuge bowl body 20 via the ring-shaped rotary frictional upper cover 30. Thus, the blood to be treated will not be deteriorated due to the rise of its temperature. Since the ring-shaped frictional area 36 provided on the ring-shaped rotary frictional upper cover 30 is made of plastic materials, it can be manufactured together with the ring-shaped rotary frictional upper cover 30 by the conventional injection molding apparatus, so that the material of the ring-shaped frictional area 36 can be directly formed and integrated on the ring-shaped rotary frictional upper cover 30. As a result, the number of the elements necessary for assembling the plasmapheresis centrifuge bowl of the present invention can be reduced, thereby to increase the assembling speed while reduce the manufacturing cost. Further, it is apparent to those skilled in this art that the ring-shaped ceramic piece 32 can be integrated with the resilient element 34 in advance to reduce the time for subsequent assembling.

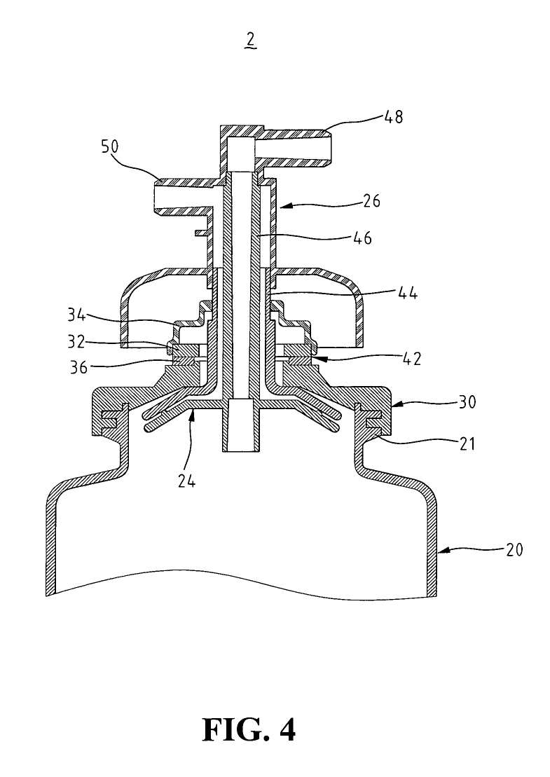

FIG. 4 is a cross-sectional view showing the state in which the plasmapheresis centrifuge bowl of the present invention has been completely assembled. The ring-shaped rotary frictional upper cover 30 of the present invention can be movably locked on the bowl mouth 21 of the plasmapheresis centrifuge bowl body 20. The integrated draining pipe assembly 24 is snapped to the underside of the ring-shaped rotary frictional upper cover 30 with an outer pipe 44 and an inner pipe 46 within the outer pipe 44 penetrating through the ring-shaped rotary frictional upper cover 30, the ring-shaped ceramic piece 32 and the resilient element 34. The ring-shaped frictional area 36 provided on the ring-shaped rotary frictional upper cover 30 contacts with the ring-shaped ceramic piece 32 to form a dynamic seal 42. The head assembly 26 is snapped on the inner pipe 46 and the outer pipe 44 of the integrated draining pipe assembly 24. After being connected, the inlet 48 provided on the head assembly 26 can be connected with the inner pipe 46 of the integrated draining pipe assembly 24 to form a passage for guiding the blood to be treated into the plasmapheresis centrifuge bowl 2 of the present invention. The outlet 50 provided on the head assembly 26 can be connected with the outer pipe 46 of the integrated draining pipe assembly 24 to form a passage for draining the thus-treated blood out of the plasmapheresis centrifuge bowl 2 of the present invention.

When the blood treatment is carried out, the head assembly 26, the ring-shaped ceramic piece 32, the resilient element 34 and the integrated draining pipe assembly 24 of the plasmapheresis centrifuge bowl 2 of the present invention are kept static, while the plasmapheresis centrifuge bowl body 20 and the ring-shaped rotary frictional upper cover 30 locked thereon rotate dynamically. At the dynamic seal 42, the heat generated by the friction can be conducted and then dissipated by the ring-shaped ceramic piece 32 having higher heat transfer rate.

What is claimed is:

1. A plasmapheresis centrifuge bowl, comprising:
a plasapheresis centrifuge bowl body;
a ring-shaped dynamic sealing assembly movably locked on the bowl mouth of the plasapheresis centrifuge bowl body and having a ring-shaped static frictional assembly and a ring-shaped rotary frictional upper cover, the ring-shaped static frictional assembly and the ring-shaped rotary frictional upper cover each having a sealing surface respectively, a dynamic seal provided between the contacting portions of the sealing surface of the ring-shaped static frictional assembly and the sealing surface of the ring-shaped rotary frictional upper cover;
an integrated draining pipe assembly provided below the ring-shaped dynamic sealing assembly; and
a head assembly mounted on the ring-shaped dynamic sealing assembly and snapped to the integrated draining pipe assembly;
wherein the ring-shaped static frictional assembly comprises a ring-shaped ceramic piece and a resilient element integrated on the ring-shaped ceramic piece, a ring-shaped frictional area is provided on the ring-shaped rotary frictional upper cover, and the heat transfer rate of the ring-shaped frictional area is less than the heat transfer rate of the ring-shaped ceramic piece.

2. The plasmapheresis centrifuge bowl as claimed in claim 1, wherein the outer edge of the bowl mouth of the plasmapheresis centrifuge bowl body is provided with a plurality of L-shaped grooves, and the horizontal portion of each L-shaped groove extends downwardly with respect to the horizontal axis of the bowl mouth to form an angle.

3. The plasmapheresis centrifuge bowl as claimed in claim 2, wherein the range of the angle is from 1 to 15 degrees.

4. The plasmapheresis centrifuge bowl as claimed in claim 2, wherein the inside of the bottom of the ring-shaped rotary frictional upper cover is provided with a plurality of projections at the positions corresponding to those of the L-shaped grooves.

5. The plasmapheresis centrifuge bowl as claimed in claim 2, wherein the number of the L-shaped groove is 2 to 6.

6. The plasmapheresis centrifuge bowl as claimed in claim 1, wherein the ring-shaped frictional area is directly manufactured on the ring-shaped rotary frictional upper cover by the injection molding technique.
